(19) United States
(12) Patent Application Publication
(10) Pub. No.: US 2016/0321697 A1
(43) Pub. Date: Nov. 3, 2016

(54) Venue Entertainment Promotional System

(71) Applicant: Anthony Chaney, Centreville, VA (US)

(72) Inventor: Anthony Chaney, Centreville, VA (US)

(21) Appl. No.: 14/699,856

(22) Filed: Apr. 29, 2015

(51) Int. Cl. G06Q 30/02; H04W 4/02; G06Q 50/12; G06Q 50/00

(52) U.S. Cl. CPC G06Q 30/0259; G06Q 30/0261; G06Q 30/0267; G06Q 50/01; H04W 4/021; G06Q 50/12

(57) ABSTRACT

Disclosed is a system and computer-implemented method for venues to promote real-time events to subscriber mobile devices, and conversely, for mobile device users to see events at venues in real-time on mobile devises. Venues may provide promotions via a hosted mobile application. Mobile device users may use a plurality of features in the application such as making a reservation, ordering food or drink prior to arrival, and using a social media function to see who the user knows is at the venue.

### GLOSSARY

Computing Device: any device used for computing purposes that includes a computer processing component such as a CPU, DSP, FPGA, ASIC, or other processor. Computing devices consist of computers, desktop servers, and portable computing devices.

Server: In the client/server programming model, a server is a program that awaits and fulfills requests from client programs in the same or other computers. A given application in a computer may function as a client with requests for services from other programs and also as a server of requests from other programs.

Portable Computing Device/Portable Electronic Device/Mobile Device: portable computing devices refer to any computing device designed and used such that the device may be carried or transported easily to any location and used. Examples include laptop computers, tablet computers, mobile phones, smart watches, and smart glasses.

Venue Computing System: any computing device or portable computing device located at a venue.

Venue Camera: a video camera located at a venue capable of uploading a live video feed to the server.

Venue: a place or location with an event taking place. The term “venue” is used interchangeably with the terms nightclub, club, bar, restaurant, lounge and dance floor.

Link: used interchangeably with URL (uniform resource locator) or web site address.

Promotions: used interchangeably with coupons or specials; an enticement for a user to attend an event such as a discount on food or entry to the venue.

Social network: any program where a user may connect via other users to share information. Specific examples include Facebook, Twitter, and Snapchat.

### FIELD

The present disclosure relates generally to a social media application for users to “club hop” via a mobile device application without physically traveling from venue to venue. Further, venues use the application to promote specials and events via the mobile application to attract customers.

### SUMMARY

The present disclosure provides a system for providing real-time information about a venue to mobile device users and provides the mobile device users the ability to interact with the venue for various services.

In accordance with one or more embodiments, a mobile device application is provided for mobile device users. Users may view a live video feed of participating venues. Additional information about each venue is provided to the user including the address, contact phone numbers, a link providing a map with directions, a web address, and any current promotions.

In accordance with one or more embodiments, the mobile device application comprises a geo-fencing feature in which the user's location is provided to the host server with a desired geo-fence distance from venues. Based on the location service and determined distance from the venue, the host server may send notifications of promotions or advertisements to the user's device.

The present invention provides improvements in the art by providing more bi-directional communications between the venue and potential customers, mobile device users, via a hosted server application. While providing a video feed of a venue is well known in the art, the present invention provides a plurality of interactive features for the user to participate in the venue prior to physical arrival.

Interactive features provided to the mobile device user include locating a venue based on preferred location, viewed video feed, event type such as music type, promotions, or specials, or friends either at the venue or will be at the venue based on a social networking function. Additional features include making reservations for a table or entry to the venue, reserving a preferred place in line for entry to the venue, place an order for beverages or food, make a request for music, place an order for beverages or food for another person at the venue, and linking with a social network application such as Facebook to find friends at certain venues, send messages to friends to meet at a certain venue, or post and invitation to attend a venue. Additionally, a meeting/dating applet is provided where registered users can make photos available for sharing to agree to meet at the venue, or meet while both parties are already at the venue.

In accordance with one or more embodiments, a non-transitory computer-readable storage medium is provided, the computer-readable storage medium tangibly storing thereon, or having tangibly encoded thereon, computer readable instructions that when executed cause at least one processor to assemble and deliver communications to provide an application on a mobile electronic device.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### IMPROVEMENT OVER PRIOR ART

Embodiments of the invention provide significant improvements over existing prior art. Although there exist some types of real time event viewing from venues including promotions and advertisements from participating venues, a full interactive experience provides significant improvements over existing systems. The plurality of features such as placing orders and purchasing items prior to arrival provide new functions to event viewing. Social networking functions as described in further detail provide a new level of interaction with other users at a venue, even prior to arrival at the venue, that has not been available in existing systems.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of the system.

FIG. 2 is a block diagram of a computing system according to some embodiments of the present disclosure.

FIG. 3 is a block diagram of the system showing the flow of the live video feed.

FIG. 4 is a block diagram of the system showing the flow of data from the mobile device user to perform certain functions.

FIG. 5 is a block diagram of the system showing the flow of data from venue sending promotion data to the mobile device user.

FIG. 6 is a diagram of the system showing a geofence of the mobile device user.

FIG. 7 is a diagram of the system showing a social media use of the mobile device user with a mobile device user inside the venue.

### DESCRIPTION OF EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended.

Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense. The Detailed Description is not intended as an extensive or detailed discussion of known concepts, and as such, details that are known generally to those of ordinary skill in the relevant art may have been omitted or may be handled in summary fashion.

For the purposes of this disclosure, a computer-readable medium (or computer-readable storage medium/media) stores computer data, which data can include computer program code that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM (random access memory), ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

In various embodiments, a hosted server, or cloud server, provides communication services between mobile device users and event venues. The hosted server provides a system for providing real-time information about a venue to mobile device users and provides the mobile device users the ability to interact with the venue for various services.

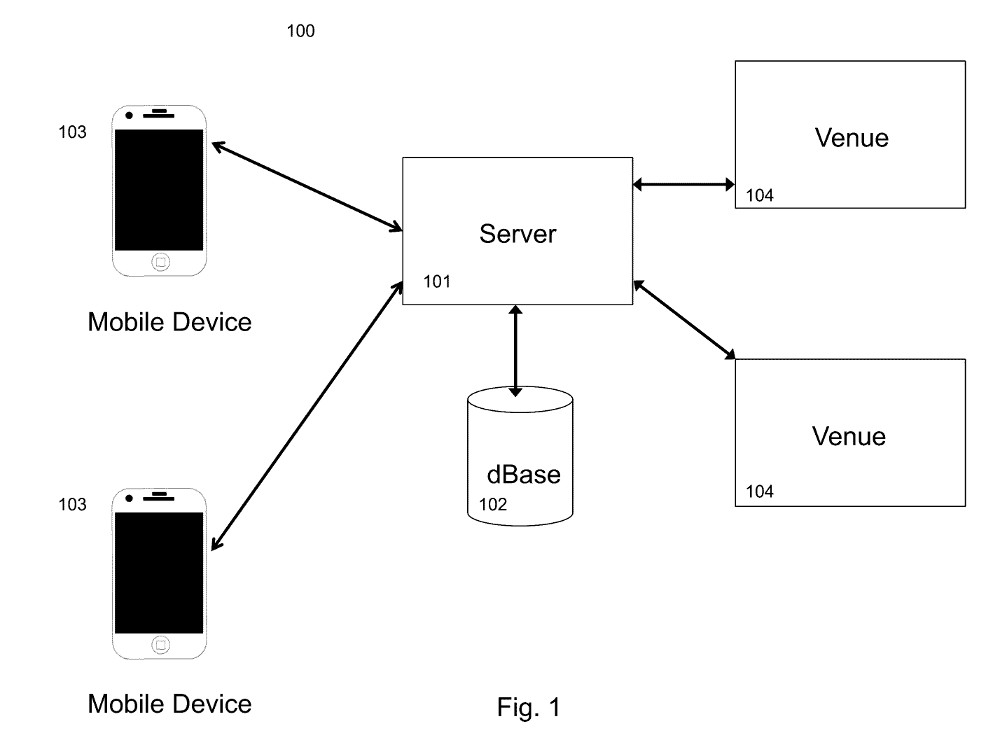

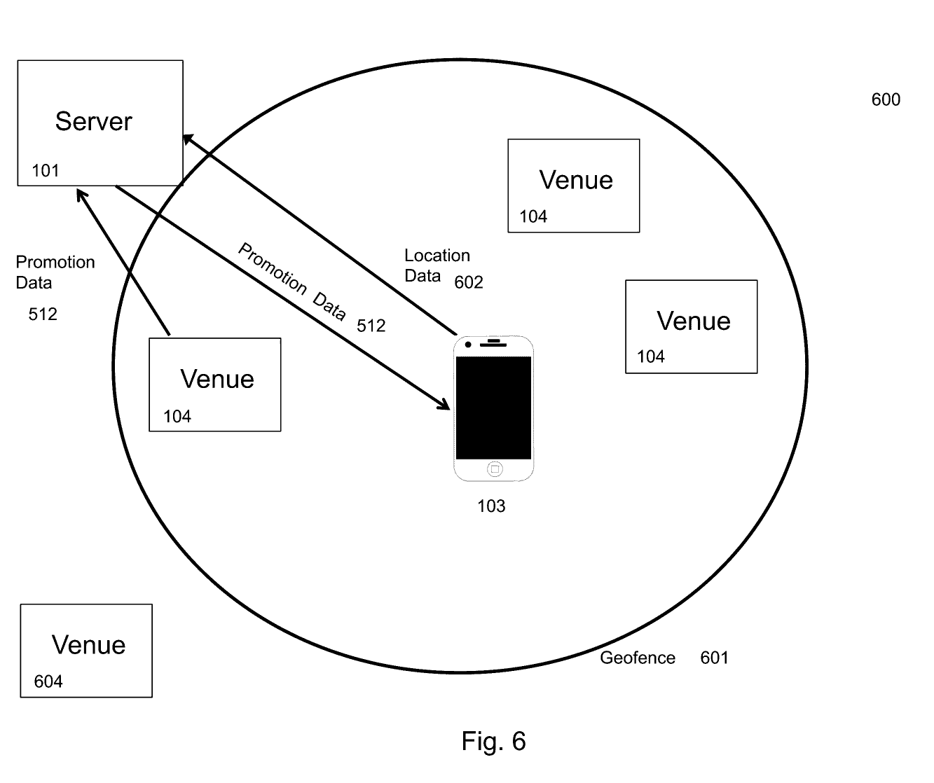

The preferred embodiments of the present disclosure will now be described with reference to FIGS. 1-7. The embodiments of the present disclosure provide for an interactive experience between mobile device users and event venue. An application, or applet, is provided on the mobile device that wheel enables a user to view live event data and interact with other users at the event and interact with the event. Specifically, the application enables the mobile device user to locate a venue, view a live video feed from the venue, and use additional features that include making reservations for a table or entry to the venue, reserving a preferred place in line for entry to the venue, place an order for beverages or food, make a request for music, make a place an order for beverages or food for another person at the venue, and linking with a social network application such as Facebook to find friends at certain venues, send messages to friends to meet at a certain venue, or post and invitation to attend a venue. Additionally, a meeting/dating applet is provided where registered users can make photos available for sharing to agree to meet at the venue, or meet while both parties are already at the venue.

FIG. 1 is a block diagram of the system 100. The server, 101, is a hosted server that manages the communications between the mobile device users 103 and the venues 104. A database 102 stores information related to the users and the venues.

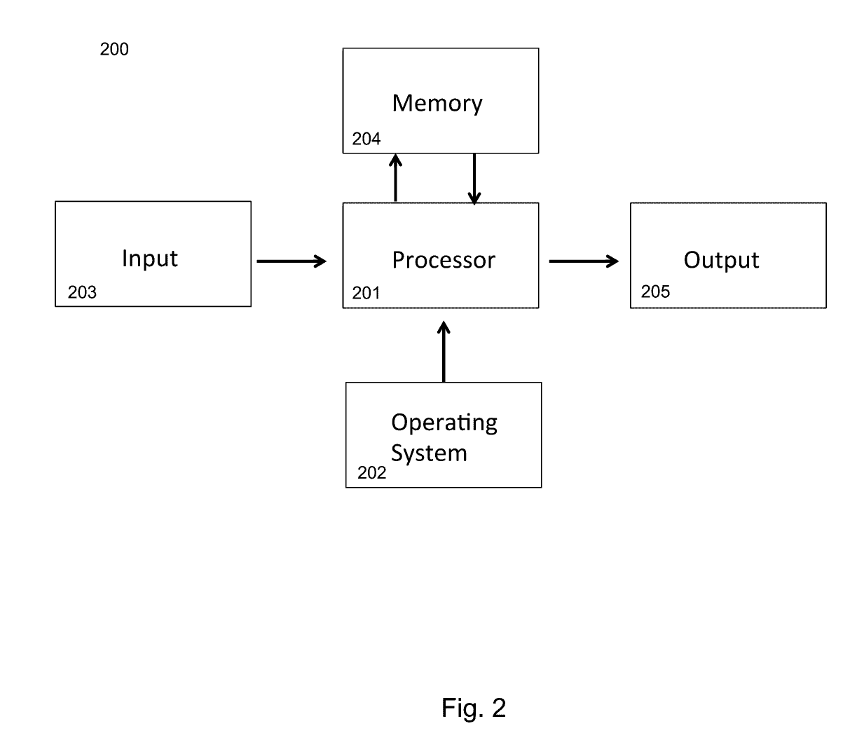

FIG. 2 is a block diagram of a computing system or portable computing device 200 that implements the disclosed invention. The computing device comprises one or more processors, CPU's, DSPs, ASICs, or any known computer processing circuit 201, to execute computer instructions to provide the functions of the system. Input 203 is provided to the processor via a touch screen interface, mouse, graphic pad, or any known input method to a graphical user interface. The computing device processor 201 is controlled by a control element 202 including a BIOS, operating system, or application program. Instructions program functions are stored in short term memory 204, and data related to the users or venues are stored in long term memory 204.

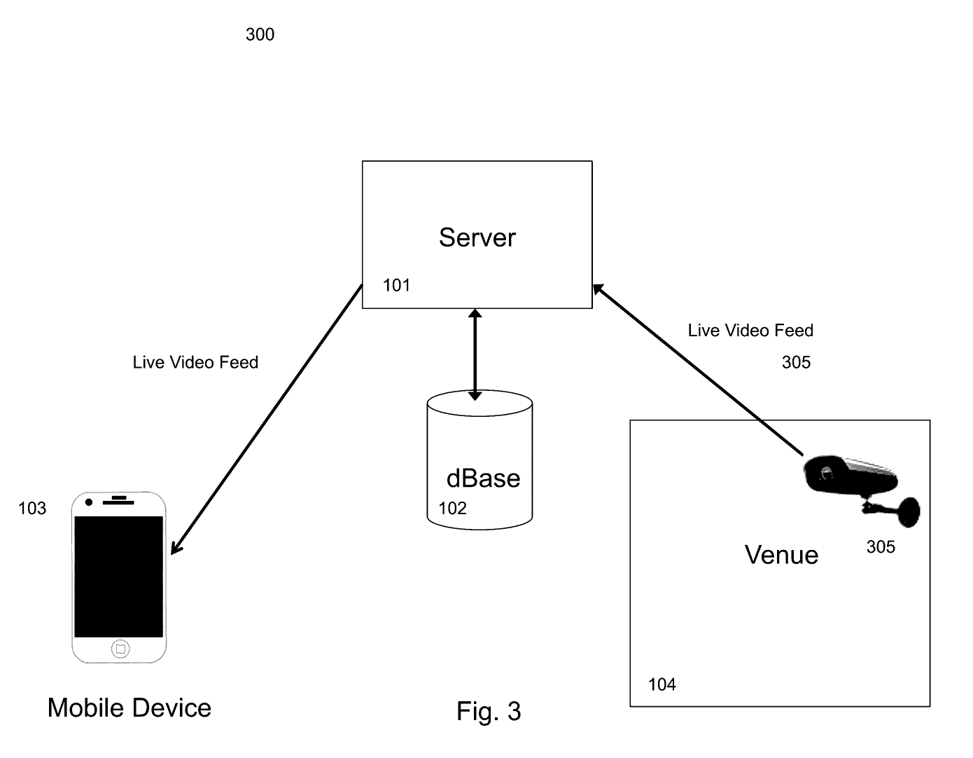

FIG. 3 is a block diagram of a system 300. One or more cameras 305 are located at the venue that provides a live video feed 305 to the server 101. The live video fee 305 is accessed by one or more mobile devices 103. The mobile device user may access any venue that provides video to the system. Viewing time may be limited depending on user subscription type or preferences of the venue. Audio may be provided in lieu of video if the mobile device user selects listening to music only.

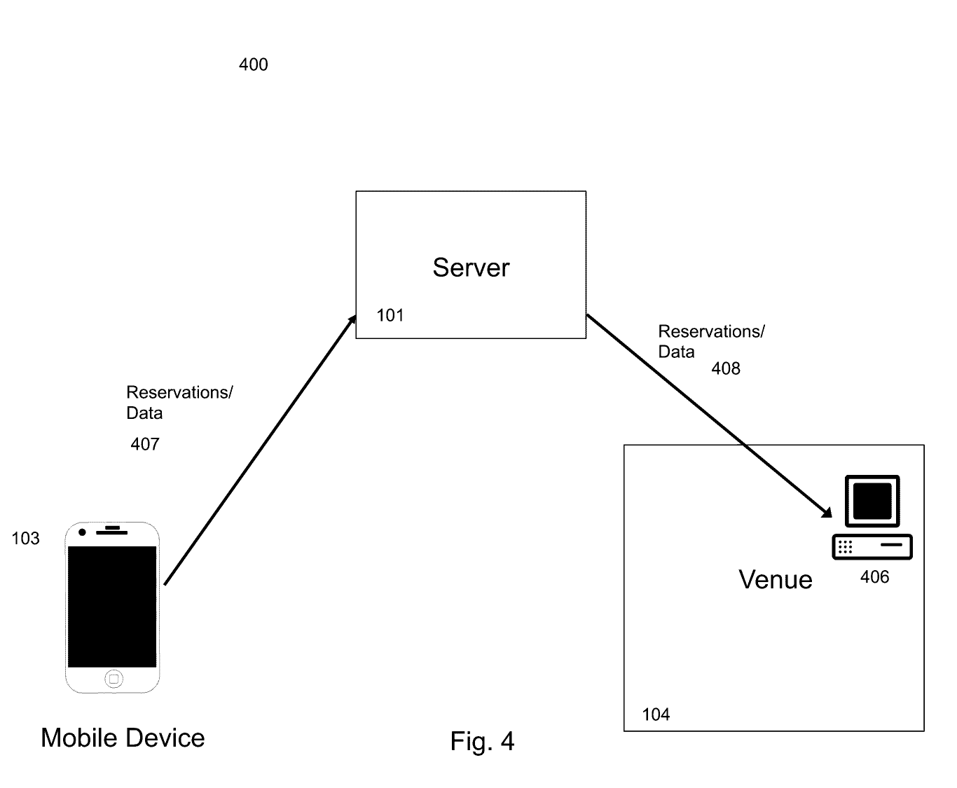

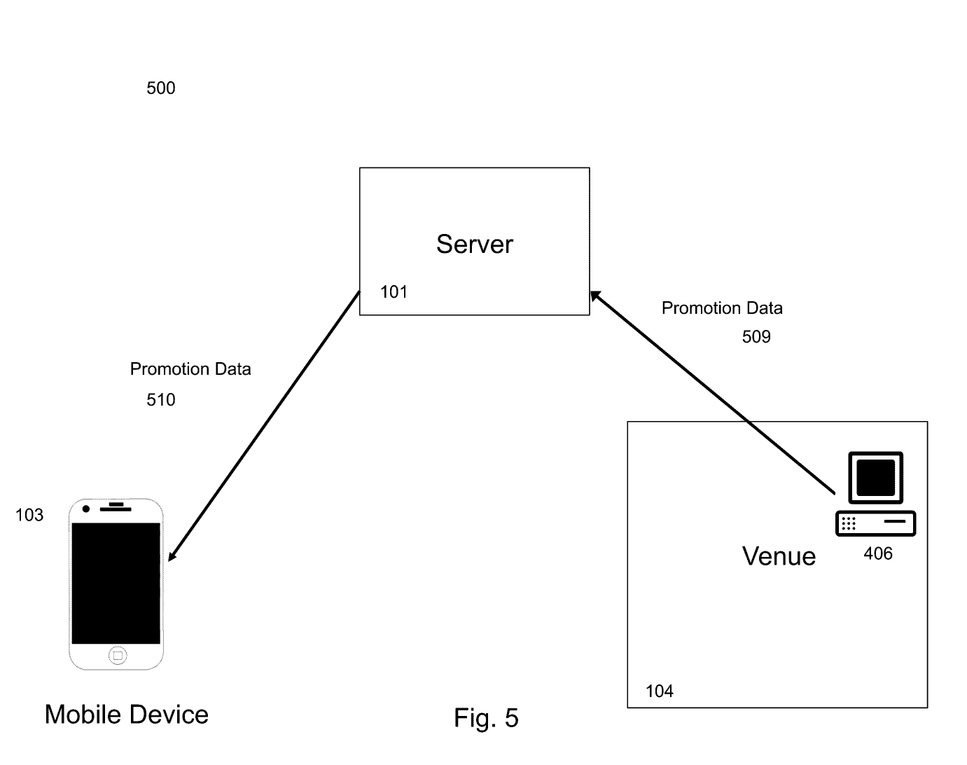

FIG. 4 is a block diagram of a system 400. An application is provided (not shown) for the mobile 103 device to access the server 101. Interactive features provided to the mobile device user via the application include locating a venue based on preferred location, viewed video feed, event type such as music type, promotions, or specials, or friends either at the venue or will be at the venue based on a social networking function. As shown in FIG. 5, promotional data 509 is transmitted from the venue 104 computing device 408 to the server 101, and further transmitted 510 to the mobile device user 103 for viewing.

Additional features include making reservations for a table or entry to the venue, reserving a preferred place in line for entry to the venue, place an order for beverages or food, make a request for music, and make a place an order for beverages or food for another person at the venue.

Referring back to FIG. 4, when the mobile device user 103 selects any of the reservation or ordering functions, the data 407 is transmitted to the server 101 and further transmitted to the venue 104 computing system 408.

FIG. 8 is a block diagram of a system 800 showing a geofence for a user. A user may only want to view venues within a preferred distance. The user may select a preferred distance to view venues 104. Location data 602 is sent from the mobile device 103 to the server 101. Based on the location of the mobile device, including continuous updates of location data, a geofence 801 is set up such that the user may view participating venues that are located within the user's personal geofence. Note that a venue located outside of the geofence 804, is not available for the user to interact with.

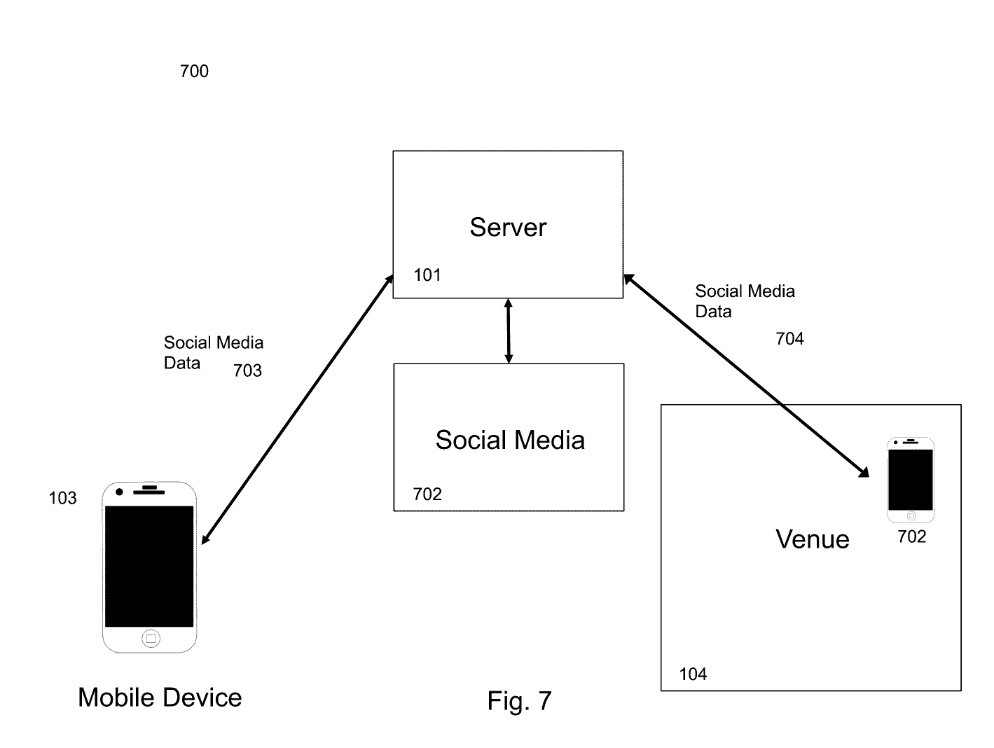

FIG. 7 is a bock diagram of a system 700 showing the social media portion of the system. The server 101 may access a social media system 702 as permitted by the mobile device users 103, 702. This allows the users to use social media, such as facebook, for contact information, messaging, and other feature while remaining in the mobile device application of this invention without the need for going back and forth between applications.

Social media functions include linking with a social network application such as Facebook to find friends at certain venues, send messages to friends to meet at a certain venue, or post and invitation to attend a venue. Additionally, a meeting/dating applet is provided where registered users can make photos available for sharing to agree to meet at the venue, or meet while both parties are already at the venue.

A mobile device user 103 may communicate with a mobile device user 702 that is already located at the venue, or may communicate with a mobile device user not at the venue but who is also in contact with the venue or linked to the mobile device user via social media (not shown). Social media data 703 is transmitted bi-directionally between the mobile device 103 and the server 101, and social media data 704 is further transmitted bi-directionally between the server 101 and the mobile device user 702 located at the venue 104. Subscribers may optionally load pictures into a user profile that may be shared with other users. An additional function of the mobile device application enables the users to share photos, view photos of other users that are at the venue or currently viewing the venue (or within their own personal geofence of the venue), and further enables the users to make contact with one another via the application.

1. A computer-implemented method for interacting with an entertainment venue comprising:
viewing a live video feed from at least one of a plurality of entertainment venues;
viewing information related to each of the live video feed entertainment venues, the information comprising at least two of:
a venue address,
a venue contact phone number,
a link providing a map with directions to the venue,
a venue web site link, and
a listing of any current venue promotions;
communicating wirelessly to a server providing a plurality of interactive features for a device, wherein one of the plurality of interactive features comprises locating a venue based on:
a geofence related to the mobile device, and
a preferred distance area from said mobile device;
linking with a social network application through the server; and
using a social media application program on the mobile device to communicate with the social network application and another mobile device, wherein, the another mobile device is interacting with the server.

2. The computer-implemented method of claim 1, wherein:
one or more cameras in one or more locations of a venue provide the live video feed to the server;
the live video feed from the one or more cameras is viewed using a mobile device application in communication with the server; and
the viewing time of the video feed from any of the one or more cameras may be limited by the server.

3. The computer-implemented method of claim 1, wherein the mobile device social media application program provides at least two of the:
venue address,
venue contact phone number,
link providing a map with directions to the venue,
venue web site link, and
listing of any current venue promotions.

4. The computer-implemented method of claim 1, further comprising:
initiating the geofence around the user's current location;
sending location data from the device to the server; and
updating the geofence when the user's mobile device sends updated location data to the server.

5. The computer-implemented method of claim 4, further comprising:
viewing entertainment venues within a preferred distance of a current location of the mobile device based on the geofence.

6. The computer-implemented method of claim 1, wherein the interactive features comprise at least one of:
locating a venue of based on one of: preferred location,
viewing a live video feed,
venue type,
music type, and
current promotions; and
further comprising at least two of:
making reservations for entry to the venue,
for a table at the venue, and
a preferred place in line for entry to the venue.

7. The computer implemented method of claim 6, wherein the interactive features further comprise placing an order for beverages or food for another person currently at the venue.

8. The computer-implemented method of claim 1, wherein linking with a social network application through the server comprises linking with a user's social network program.

9. The computer-implemented method of claim 1, wherein the social network application:
comprises a program on the mobile device; and
provides the following capabilities:
make photos or video messages available for sharing,
view photos or video messages posted by the another mobile device,
wherein the another mobile device comprises a mobile device user one of:
planning to attend the venue, and
already present at the venue, and
share messages with the mobile device users.

10. A system for enabling mobile device users to interact with a venue for various services, comprising:
a server comprising one or more processors and a memory;
a mobile device comprising an application, wherein, the mobile device is communicatively coupled to the server;
a plurality of venues comprising one or more cameras communicatively coupled to the server; and wherein the mobile device application enables viewing a live video feed from at least one of the one or more cameras;
communicating wirelessly with the server providing a plurality of interactive features, wherein one of the plurality of interactive features comprises locating the plurality of venues based on at least one of:
a preferred location,
a geofence related to the mobile device, and
a preferred distance from said mobile device,
linking with a social network application, and
using the social network application program to communicate with another mobile device, wherein the another mobile device is interacting with one or more venues of the plurality of venues.

11. The system of claim 10, wherein,
the one or more cameras;
comprise cameras in one or more locations within each of the plurality of venues, and
are operable to provide a live video feed to the server, and further wherein
the live video feed from the one or more cameras is accessed using the application;
the application is in communication with the server; and
a viewing time of the video feed may be limited in time by the server; and the video fees if from at least one of:
one of the plurality of venues; and
an individual camera.

12. The system of claim 10, wherein the information comprises at least two of:
an address of the venue;
a contact phone number of the venue;
a link providing a map with directions to the venue;
a web site URL of the venue; and
a listing of any current promotions of the venue.

13. The system of claim 10, wherein:
the application, initiates the geofence around the mobile device's current location;
location data is sent from the mobile device to the server; and
the geofence is updated when the mobile device sends updated location data to the server.

14. The system of claim 13, wherein the server and geofence enables a user to view one or more of the plurality of venues within the preferred distance.

15. The system of claim 10, wherein,
the application enables the at least one of the plurality of interactive features based on one of:
the preferred location,
viewing the live video feed,
a venue type,
a music type, and
the current venue promotions; and
the application enables the at least one of the plurality of interactive features based on at least two of:
making reservations for entry to the venue,
making reservations for a table at the venue, and
making reservations for a preferred place in line for entry to the venue.

16. The system of claim 10, wherein the mobile device application further enables placing an order for beverages or food for another person currently at the venue.

17. The system of claim 10, wherein linking with a social network application comprises linking with a mobile computing device user's social network program through the server.

18. The system of claim 10, wherein the social network application program enables:
making photos or video messages available for sharing;
viewing photos or video messages posted by another user other than the mobile computing device user; and
sharing messages with the another user;
the another user is one of:
planning to attend the venue, and
already present at the venue.

19. A non-transitory, tangible computer-readable storage medium, computer comprising processor-readable instructions to perform a method of operating an social media application program on a mobile computing device comprising:
enabling interaction with at least one of a plurality of venues;
viewing a live video feed from the of at least one of a plurality of venues;
viewing information specific to each of the plurality of venues, the information comprising at least two of:
a venue address,
a venue contact phone number,
a link providing a map with directions to a venue,
a venue web site address, and
a listing of any current venue promotions;
communicating wirelessly to a hosted server providing a plurality of interactive features for a mobile device user, wherein:
at least one of the plurality of interactive features comprises locating a venue based on one of a preferred location and a geofence related to the mobile computing device,
the one of a preferred location and a geofence related to the mobile computing device comprises a preferred distance area from said mobile computing device;
linking with a social network application on the hosted server; and
using the social media application program on the mobile device to communicate though the hosted server with other mobile computing devices interacting with one or more of the plurality of venues.

20. The non-transitory computer-readable storage medium of claim 19, wherein:
one or more cameras in one or more locations of the plurality of venues are operable to provide the live video feed;
the live video feed:
is provided from the one or more cameras to the hosted server, and
may be viewed using the social media application program in communication with the social network application on the hosted server; and
a viewing time of the live video feed from is limited by the hosted server.

21. (canceled)

22. The non-transitory computer-readable storage medium of claim 19, further comprising:
initiating a geofence around a current location of the mobile device;
sending location data from the mobile device to the hosted server;
updating the geofence when the mobile device sends updated location data to the hosted server; and
using information from the geofence to display at least one venue within a preferred distance of the current location of the mobile device.

23. The non-transitory computer-readable storage medium of claim 19, wherein at least one of the plurality of interactive features further comprises locating a venue of based on at least one of:
a live video feed,
a venue type,
a music type,
current promotions; and
making reservations for at least two of:
entry to the venue,
a table at the venue, and
a preferred place in line for entry to the venue.

24. The non-transitory computer-readable storage medium of claim 19, wherein at least one of the plurality of interactive features further comprises placing an order for beverages or food for another person currently at the venue.

25. The non-transitory computer-readable storage medium of claim 19, wherein linking with a social network application on the hosted server comprises establishing communication between the social network application and the social media application program on the mobile device.

26. The non-transitory computer-readable storage medium of claim 19, wherein the social media application program on the mobile device enables the user to:
make photos video available for sharing;
view photos or video messages posted by other users; and
share messages with the other users, wherein the other users are one of:
planning to attend the venue, and
are already at the venue.
